(19) United States
(12) Patent Application Publication
(10) Pub. No.: US 2003/0154161 A1
(43) Pub. Date: Aug. 14, 2003

(54) Single premium annuity for satisfying an equity loan

(76) Inventors: Lowell I. Stahl, Northbrook, IL (US); Frank J. Kross, Lemont, IL (US); Frank J. Perroni, Plainfield, IL (US); Herbert R. Williams, Chicago, IL (US)

Correspondence Address: VEDDER PRICE KAUFMAN & KAMMHOLZ, 222 N. LASALLE STREET, CHICAGO, IL, 60601, US

(21) Appl. No.: 10/074,866

(22) Filed: Feb. 13, 2002

(51) Int. Cl. G06F 17/60

(52) U.S. Cl. 705/38

(57) ABSTRACT

A method, system, and software program manages a home equity loan to a borrower by way of channeling annuity proceeds to the monthly payments of the home equity loan. The equity in a borrower's home is determined, and if the loan-to-value is below a certain threshold, the loan is granted. An escrow account is established, and the proceeds of the loan are used to purchase a commercial annuity. The proceeds of the commercial annuity in turn are used to satisfy the monthly payments on the home equity loan. Moreover, current and future debts of the borrower can also be satisfied by way of the proceeds of the loan. The present invention assumes a periodic increase in the future debts of the borrower.

### FIELD OF THE INVENTION

The present invention relates to the field of equity loans, and in particular to the use of a single premium annuity to satisfy the payments due on an equity loan granted to a borrower. The present invention is useful primarily for lending to borrowing homeowners based on equity in their home where no preexisting mortgages are outstanding against their homes.

### BACKGROUND OF THE INVENTION

Reverse mortgages are well known in the field of financing by way of the equity in a borrower's property, typically a home. In a reverse mortgage, deeply indebted homeowners borrow against the equity in their property without having to pay it back immediately. The loan however must be repaid with interest when the last living borrower dies, sells, or permanently moves out of the home. When this happens, the property is deeded to the lender. This is unattractive to many property owners who are emotionally unwilling to sell at the present time. Moreover, the borrower would continue to be responsible for any taxes, insurance, and other expenses incurred both prior to and after the grant of the loan, having no provision for cash in hand to the borrower.

An example of such a reverse mortgage is disclosed in Mazonas, et al. (U.S. Pat. No. 6,012,047). The property securing the loans is evaluated for present and future worth. The age of the borrower is used to make an actuarial assessment of future cash flow that can be provided for the rest of his or her life. The balance is then struck between the diminishing equity in the house and the potential future need of income due to survival beyond the depletion date of this equity. Once the loan attributes are established and the loan is closed, a loan management system controls the day-to-day management of servicing the loan including by way of example, the payment of fixed or variable periodic payments. A line of credit option is available to the borrower who elects to take less than the maximum payment available in the form of monthly reversed mortgage payments because the borrower does not want or need monthly income. Loans are provided to borrowers, which are delivered in periodic payments in accordance with loan management system parameters. Individual accounts are stored in memory and routinely updated by the system manager. The loan is typically repaid from the proceeds that accrue from the sale of the property used to secure the loan (such as the house). The system manages the risk associated with the credit by structuring a concurrent single premium deferred annuity to provide future cash flows starting at a system determined date corresponding to actuarially determined requirements of the borrower.

Thus, a need exists for a method, system, and software program that provide an equity loan in which the estate of the borrower maintains ownership of the property by way of an insured mechanism for making the required periodic loan payments. In the preferred embodiment, the method, system, and software program will also provide for payment of insurance, taxes, and other related expenses, and will also provide for payment of expenses incurred subsequent to the grant of the loan, compensating for predictable increases in those expenses.

### SUMMARY OF THE INVENTION

The present invention achieves its objects and others by providing a method, system, and software program to manage a home equity loan to a borrower by way of channeling annuity proceeds to the monthly payments of the home equity loan. The equity in a borrower's home is determined, and if the loan-to-value is below a certain threshold, the loan is granted. Because the payments against the loan are guaranteed, no other qualifying information is necessary. An escrow account is established, and the proceeds of the loan are used to purchase a commercial annuity. The proceeds of the commercial annuity in turn are used to satisfy the monthly payments on the home equity loan. Moreover, current and future debts of the borrower can also be satisfied by way of the proceeds of the loan. The present invention assumes a periodic increase in the future debts of the borrower.

### BRIEF DESCRIPTION OF THE DRAWINGS

The features of the present invention will be more readily understood from the following detailed description of examples of embodiments thereof when read in conjunction with the accompanying drawings, of which:

FIG. 1 is a diagram depicting an apparatus in accordance with the present invention; and

FIG. 2 is a flowchart illustrating the process of applying the single premium annuity to an equity loan in accordance with the present invention.

### DETAILED DESCRIPTION OF THE PREFERRED EMBODIMENT

Although the present invention may be embodied in a number of different forms and the elements may be arranged in different configurations, a preferred embodiment of one form of the invention is shown. Other embodiments or arrangements of components will be apparent to those skilled in the art, and such changes and modifications may be made without departing from the scope of this invention.

The present invention provides a method, system, and software program for managing an equity loan to a borrower by way of channeling annuity proceeds to the monthly payments of the equity loan. The equity in a borrower's property (typically a home) is determined, and if the loan-to-value is below a certain threshold, the loan is granted. An escrow account is established, and the proceeds of the loan are used to purchase a commercial annuity. The proceeds of the commercial annuity in turn are used to satisfy the monthly payments on the equity loan. Moreover, current and future incurred outstanding debts of the borrower can also be satisfied by way of the proceeds of the loan.

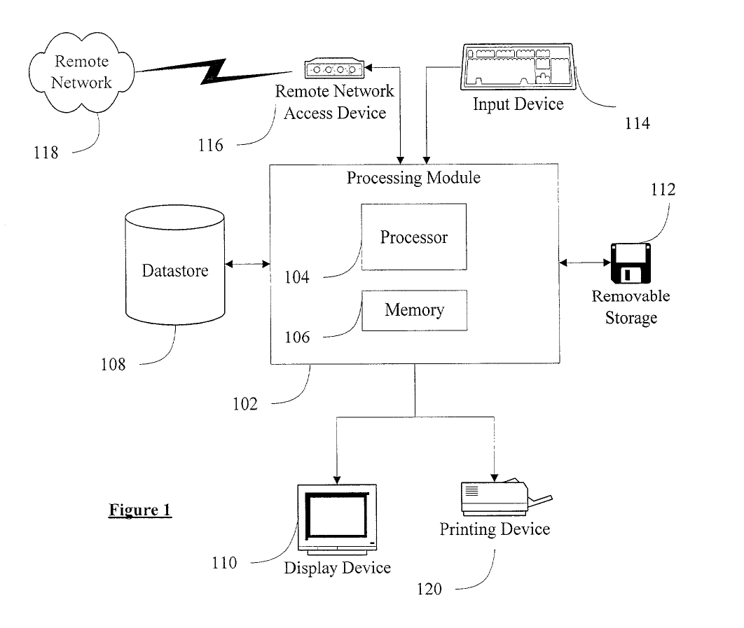

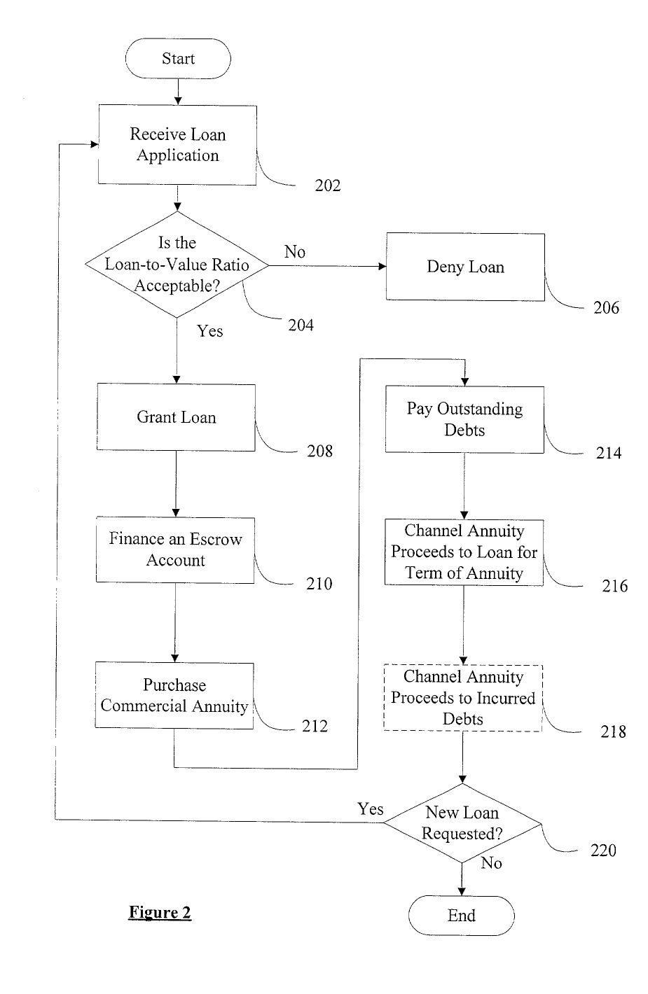

Referring now to the drawings in greater detail, FIG. 1 is a diagram of an apparatus representing an embodiment of the present invention. A processing module 102 receives and transmits data related to the present invention, and includes a processor 104 and memory 106 as are commonly known in the art. The processor 104 and memory 106 facilitate management of the operations of the processing module. The processor 104 may be a microprocessor, application-specific integrated circuit (ASIC), field programmable gate array (FPGA), a digital signal processor, a micro-controller, or any other suitable processing device. If the processor 104 is a microprocessor, it can be a “PENTIUM,” “POWER PC,” or any other suitable microprocessor commonly known in the art. The memory 106 may be read only memory, random access memory, rewritable disk memory, write-once-read-many disk memory, electrically erasable programmable ROM (EEPROM), or any other suitable memory device commonly known in the art. The memory 106 includes instructions that are executed by the processor 104, as well as programming variables or any other suitable programming source code commonly known in the art. The processing module 102 receives input from an input device 114 as is commonly known in the art. By way of example only, such an input device could be a keyboard or a plane device, such as a mouse, track ball, or any other suitable hardware commonly known in the art. A display device 110 provides a user interface (not shown) to facilitate user input using the input device 114. The user interface can receive, by way of example, information related to the property owner, the property itself, the insurance carried by the property owner, and any other information relevant to the grant of a loan as discussed in reference to FIG. 2 below.

The processing module 102 accesses a datastore 108 that holds all data relevant to the computations of the present invention. By way of example only, this information includes, among other things, market based information and borrower based information. The datastore 108 can take any format well known in the art. For example, such a format can be that of a relational database, a non-relational database, a record manager, a flat file, or any other suitable datastore format commonly known in the art.

After the processing module 102 receives user input and processes it accordingly, the processing module 102 formats and outputs the results of its processing to at least one of a plurality of selectable media. The media can be selected manually or programmatically, being performed by firmware, hardware, or software within the processing module 102. In one embodiment of the present invention, the output is transmitted to the display device 110, such as a personal computer display, a personal digital assistant (PDA) display, a television monitor, or any other suitable display device commonly known in the art. The processing module 102 can be selectively programmed to convert the output into any format suitable for the particular firmware, hardware, or software that will then display that output information. The information output by the processing module 102 may be retrieved from memory 106 for output to a different media or deleted from memory 106 based on a user's analysis of that information.

In another embodiment of the present invention, the output can be transmitted to a remote data network access device 116 as is commonly known in the art, such as a modem, network interface card, cable modem, or any other suitable remote data network access device. Through such devices commonly employed in the art, the remote data network access device 116 can transmit the output to various remote locations, such as the Internet or other remote network 118. The output can be sent to an e-mail account (not shown) as is commonly known in the art or a network based posting account as requested by at least one of the settings in the remote network or presettings in the memory 106. The network-based posting account (not shown) can take any form as is commonly known in the art, including but not limited to an HTML-based message board or an HTML-based email account on the World Wide Web.

In yet another embodiment of the present invention, the output can be transmitted to a printing device 120 as is ordinarily used in the art, to create a hard copy of the analysis of the output. In still yet another embodiment of the present invention, the output can be transmitted to a removable storage media 112 for transportation to other hardware devices (not shown) that may have the necessary connections to the needed datastore 108, display device 110, remote network access device 116, or printing device 120. The removable storage media 112 may be RAM, EEPROM, rewritable disk memory, tape, write-once-read-many disk memory, or any other suitable removable storage media commonly known in the art. One of ordinary skill in the art would recognize the availability of other media for receiving the output of the analysis.

FIG. 2 is a flowchart illustrating a method for managing an equity loan to a borrower in accordance with the present invention. At block 202, a loan application is received and processed. This step includes a borrower providing required information by way of a first mortgage loan application commonly known in the art. The information may be received as a written application, electronic submission, oral recitation, or in any other suitable manner. The information is taken by a loan officer or any individual qualified and authorized to receive the information, and is provided to an embodiment of the present invention as discussed with respect to FIG. 1 above. The processing is performed by way of execution of the instructions in any suitable manner commonly known in the art.

At block 204, the system calculates the loan-to-value ratio using techniques commonly known in the art, and determines whether that ratio is acceptable based on the predetermined system parameters. In the preferred embodiment, the loan-to-value ratio is calculated by dividing the total amount for the loan by the appraised value of the property. The loan amount is based upon the amount needed to purchase a commercial annuity that will provide proceeds sufficient to make the payments on the loan, insurance, and taxes. The amount is calculated assuming an annual increase in required taxes such that the annuity payment will be large enough at all times during the term of the loan to meet the required payments. In the preferred embodiment, the assumed annual increase in required taxes is four percent (4%). The property may be appraised using techniques commonly known in the art. In the preferred embodiment, the loan-to-value ratio is deemed acceptable when it does not exceed a threshold value. For example, typically, home-based equity loans are granted only when the loan-to-value ratio falls between zero and seventy-five percent (i.e., 0%-75%). Because the present invention is typically applied to circumstances in which the borrower in deeply indebted, in the preferred embodiment, the loan-to-value ratio should fall between zero and sixty percent (i.e., 0%-60%), with a preference for a loan-to-value ratio between zero and fifty percent (i.e., 0%-50%), and where there is no existing mortgage on the home.

If the loan-to-value ratio is not acceptable, then at block 206 the loan is denied. However, at block 208 the loan is granted if the loan-to-value ratio is acceptable. Because the payments against the loan are assured by the purchase of a commercial annuity, traditional factors such as credit rating, age of the borrower, and the income expense debt ratios are not relevant. As to the nature of an equity loan itself, however, the equity loan is granted as is commonly known in the art, having a term for repayment and an associated amortization. In the preferred embodiment, the loan is a five (5) year fixed rate balloon loan with a thirty (30) year amortization. Thus the monthly payments are established such that, although the balance is due in five (5) years, the amount of the payments is calculated based on a thirty (30) year term. Alternative embodiments may include terms differing from five (5) years, or amortizations other than thirty (30) years, or a non-balloon loan having a term identical to the amortization.

At block 210 an escrow account is financed by way of the proceeds of the loan. At block 212, using the contents of the escrow account, a commercial annuity is purchased. At block 214, the contents of the escrow account may be used to pay outstanding debts. The outstanding debts can include, by way of example, unpaid real estate taxes, insurance, and utility bills. Moreover, the contents of the escrow account may be used to pay debts incurred in the future. In the preferred embodiment, the commercial annuity will have a term of five years such that the annuity will provide a payment on a monthly basis for a five (5) year term.

At block 216 the proceeds returned by the annuity on a periodic basis are channeled to the periodic payments due on the equity loan. The payment period typically will be monthly but may be any suitable period as is well known in the art. The proceeds from the commercial annuity are channeled for the duration of the term of the annuity. At block 218 the annuity proceeds may optionally be channeled to satisfy debts incurred on a continuing basis. By way of example only, these debts can include utility bills, unexpected expenses, debt consolidation, or any other debt incurred by the borrower.

At decision block 220, upon expiration of the term of the annuity, the borrower may request a new loan. If the new loan is requested, the system returns to block 202 where a new loan application is received. If a new loan is not requested the system terminates. In the preferred embodiment, the initial loan will not be granted unless sufficient equity exists in the property such that a second loan application will be expected to be granted. A new loan can be granted as long as the requisite loan application is approved.

Those of ordinary skill in the art will recognize that the present invention makes advances in the area of equity loan management. The present invention provides a method, system, and software program for managing a property-based equity loan to a borrower by way of channeling annuity proceeds to the monthly payments of the equity loan. The borrower (or the estate of the borrower) maintains ownership of the property by way of an insured mechanism for making the required periodic equity loan payments. The equity in a borrower's property is determined, and if the loan-to-value is below a certain threshold, the loan is granted. An escrow account is established by way of the equity loan proceeds, which provides for the purchase of a commercial annuity. The proceeds of the commercial annuity in turn are used to satisfy the monthly payments on the equity loan. Moreover, current and future incurred outstanding debts of the borrower can also be satisfied by way of the proceeds of the loan.

It should be understood that the implementation of other variations and modifications of the present invention in its various aspects will be apparent to those of ordinary skill in the art, and that the present invention is not limited by the specific embodiments described. For example, the present invention may be implemented using parameters that exceed the preferred loan-to-value threshold values, other terms and amortizations may be chosen for the loan, and any form of property may be used to secure the loan. It is therefore contemplated that the present invention cover any and all modifications, variations, or equivalents that fall within the sphere and scope of the basic underlying principals claimed herein.

What is claimed is:

1. A method for managing an equity loan to a borrower comprising the steps of:
calculating an equity value of property owned by the borrower;
calculating a loan-to-value ratio of the property;
determining whether to grant the equity loan based on the loan-to-value ratio of the property;
financing an escrow account with a principal of the equity loan;
purchasing a commercial annuity using the principal of the equity loan; and
making a periodic payment against the equity loan using proceeds of the commercial annuity.

2. The method of claim 1 wherein the determining step is based on whether the loan-to-value-ratio exceeds a threshold value.

3. The method of claim 2 wherein the threshold value does not exceed 0.60.

4. The method of claim 1 further comprising:
calculating a total of other outstanding debts of the borrower; and
eliminating the total of other outstanding debts using the contents of the escrow account.

5. The method of claim 4, wherein the outstanding debts include at least one of unpaid real estate taxes, insurance, and utility bills.

6. The method of claim 1 further comprising eliminating incurred debts using the proceeds of the commercial annuity.

7. The method of claim 6, wherein the purchasing step is performed assuming a periodic increase in the incurred debts.

8. The method of claim 1, wherein the directing step is performed on a monthly basis.

9. A data processing system for managing an equity loan to a borrower comprising:
a data store;
an input device for collecting and inputting into the data processing system a set of data associated with a request for the equity loan; and
a processing module comprising:
a processor; and
memory operatively coupled to the processing module, wherein the memory stores operational instruction to cause the processing module to:
calculate an equity value of property owned by the borrower;
calculate a loan-to-value ratio of the property;
determine whether to grant the equity loan based on the loan-to-value ratio of the property;
create an escrow account for the borrower;
finance the escrow account with a principal of the equity loan;
record receipt of proceeds of a commercial annuity; and
make a periodic payment against the equity loan using the proceeds of the commercial annuity.

10. The data processing system of claim 9, wherein the memory stores further operational instructions to cause the processing module to determine based on whether the loan-to-value-ratio does not exceed a threshold value.

11. The data processing system of claim 10, wherein the threshold value is 0.60.

12. The data processing system of claim 9, wherein the memory stores further operational instructions to cause the processing module to:
calculate a total of other outstanding debts of the borrower; and
eliminate the total of other outstanding debts using the contents of the escrow account.

13. The data processing system of claim 12, wherein the outstanding debts include at least one of unpaid real estate taxes, insurance, and utility bills.

14. The data processing system of claim 9, wherein the memory stores further operational instructions to cause the processing module to eliminate incurred debts using the proceeds of the commercial annuity.

15. The data processing system of claim 9, wherein the memory stores further operational instructions to cause the processing module to direct annuity payments on a monthly basis.

16. The data processing system of claim 9 further comprising a remote network access device operatively coupled to the processor.

17. The data processing system of claim 9 further comprising a display device operatively coupled to the processor.

18. The data processing system of claim 9 further comprising a printing device operatively coupled to the processor.

19. The data processing system of claim 9 further comprising a removable media storage device operatively coupled to the processor.

20. A program storage device readable by a machine, tangibly embodying a program of instructions executable by the machine to perform method steps for managing an equity loan to a borrower, the method steps comprising:
calculating an equity value of property owned by the borrower;
calculating a loan-to-value ratio of the property;
determining whether to grant the equity loan based on the loan-to-value ratio of the property;
creating an escrow account for the borrower;
financing the escrow account with a principal of the equity loan;
recording receipt of proceeds of a commercial annuity; and
making a periodic payment of the equity loan with the proceeds of the commercial annuity.

21. The program storage device of claim 20, wherein the step of determining includes evaluating whether the loan-to-value-ratio exceeds a threshold value.

22. The program storage device of claim 21, wherein the threshold value does not exceed 0.60.

23. The program storage device of claim 20, wherein the method steps further comprise:
calculating a total of other outstanding debts of the borrower; and
eliminating the total of other outstanding debts using the contents of the escrow account.

24. The program storage device of claim 23, wherein the outstanding debts include at least one of unpaid real estate taxes, insurance, and utility bills.

25. The program storage device of claim 20, wherein the memory stores further operational instructions to cause the processing module to eliminate incurred debts using the proceeds of the commercial annuity.

26. The program storage device of claim 20, wherein the memory stores further operational instructions to cause the processing module to direct annuity payments on a monthly basis.
